(19) United States
(12) Patent Application Publication
(10) Pub. No.: US 2024/0417341 A1
(43) Pub. Date: Dec. 19, 2024

(54) COMPOSITION COMPRISING A 1,4-NAPHTHOQUINONE AND UREA AND METHODS OF MAKING AND USING

(71) Applicant: Purdue Research Foundation, West Lafayette, IN (US)

(72) Inventor: Joshua R. Widhalm, West Lafayette, IN (US)

(73) Assignee: Purdue Research Foundation, West Lafayette, IN (US)

(21) Appl. No.: 18/718,917

(22) PCT Filed: Dec. 14, 2022
(86) PCT No.: PCT/US2022/052898

§ 371 Date: Jun. 12, 2024

Related U.S. Application Data
(60) Provisional application No. 63/289,957, filed on Dec. 15, 2021.

(51) Int. Cl. C05C 9/00; C05G 3/90; C05G 5/30

(52) U.S. Cl. CPC C05C 9/00; C05G 3/90; C05G 5/30

(57) ABSTRACT

A composition comprising urea and a 1,4-naphthoquinone; method of fertilizing a plant; and method of making the composition.

### CROSS REFERENCE TO RELATED APPLICATION

This application claims priority to U.S. provisional patent application No. 63/289,957, which was filed Dec. 15, 2021, and which is hereby incorporated by reference in its entirety.

### TECHNICAL FIELD

The present disclosure relates to a composition comprising a 1,4-naphthoquinone (1,4-NQ), such as juglone, and urea and a method of using the composition to fertilize plants. The present disclosure also relates to a method of making the composition.

### BACKGROUND

1,4-naphthoquinones (1,4-NQs) are redox active compounds, which are structurally related to naphthalene and comprise a benzene linearly fused with a fully conjugated cyclic diketone in which the carbonyl groups are arranged in the para orientation. 1,4-NQs encompass a class of compounds containing a 1,4-naphthalenoid ring, which can be substituted with one or more methyl, hydroxyl, and/or methoxy substituents and sometimes a liposoluble side chain (Widhalm et al., Horticulture Res 3:16046 (2016) (doi:10.1038/hortres.2016.46). Found in every kingdom of life, plants, including many horticultural species, collectively synthesize hundreds of 1,4-NQs (Widhalm et al. (2016), supra). Examples of 1,4-NQs include juglone, menadione, shikonin, alkannin, plumbagin, lawsone (2-hydroxy-1,4-naphthoquinone), lapachol, and derivatives/analogs thereof. Derivatives and analogs of 1,4-NQs include oxidized and reduced (e.g., hydrojuglone) forms and sugar conjugates (e.g., hydrojuglone β-D-glucopyranoside).

Walnut trees, such as black walnut trees (Juglans nigra) and English walnut trees (Juglans regia), produce and/or store juglone (5-hydroxy-1,4-napthoquinone), hydrojuglone, hydrojuglone β-D-glucopyranoside, and/or other juglone derivatives or closely related compounds in various plant parts, such as husks, shells, bark, roots, stems, fruits, and leaves. Pecan trees (Carya illinoensis) also produce juglone. Juglone inhibits urease.

Urease is an enzyme in plants, fungi, and bacteria that catalyzes hydrolysis of urea to ammonia and carbon dioxide. Urease is also present and active in soil as extracellular enzyme adsorbed onto soil colloids, free in solution, and/or associated with cellular debris. It is estimated that 79-89% of urease activity in soil is due to the presence of extracellular enzyme.

Although urease plays a key role in the global nitrogen cycle, urease at the soil surface, such as in field settings, reduces the efficiency of urea-based nitrogen fertilizers—the most widely used nitrogen fertilizers—by rapidly converting the urea to ammonia, which volatilizes to the atmosphere. Depending on environmental conditions (e.g., temperature, humidity, etc.), 10-40% of nitrogen applied as urea can be lost as ammonia from the soil surface.

The application of urease inhibitors, either directly to the soil surface or coated onto urea-based nitrogen fertilizer granules, are an effective way to reduce the conversion of urea to ammonia by extracellular ureases. Delaying the conversion of urea to ammonia at the soil surface enables the urea to penetrate the soil with rain, irrigation, or other means. Once washed into the soil to a depth of ˜5-10 cm, ammonia released from urea is trapped and mineralized to plant-usable forms.

The urea structural analog N-(n-butyl)thiophosphoric triamide (NBPT) has been used worldwide. It is the lead urease inhibitor in a market estimated to have grown 16% annually from around 2007-2017 (Cantarella et al., J Adv Res 13:19-27 (September 2018)). Urea treated with NBPT reduces ammonia production by around 53% (Cantarella et al. (September 2018), supra). This translates to a yield gain that ranges from −0.8 to 10.2% depending on the crop species (Cantarella et al. (September 2018), supra).

The effectiveness of urease inhibitors like NBPT has been well-studied in perennial grass systems. While effective, there is growing demand for inexpensive, natural, and more eco-friendly alternatives to NBPT. In view of the foregoing, it is an object of the present disclosure to provide such an alternative. This and other objects and advantages, as well as inventive features, will become apparent from the detailed description provided herein.

### SUMMARY

Provided is a composition comprising urea and a 1,4-naphthoquinone (1,4-NQ), wherein the 1,4-NQ can inhibit urease. The composition can be used to fertilize a plant. The 1,4-NQ can be juglone. The urea can be granular, and the 1,4-NQ can be coated onto or impregnated in the granules. Alternatively, a homogenous mixture of urea and the 1,4-NQ, alone or in further combination with other ingredients, can be granulated. The 1,4-NQ can be natural, synthetic, or semi-synthetic. The 1,4-NQ can be purified. The 1,4-NQ can be juglone contained within particulate material obtained from a walnut tree or a pecan tree. The particulate material can be obtained from husks, shells, bark, roots, stems, fruits, and/or leaves of the walnut tree. The particulate material can be obtained from husks, fruits, or both husks and fruits of the walnut tree.

Further provided is a method of fertilizing a plant located in soil. The method comprises administering to the surface of the soil the composition. The plant can be a grass, such as turf grass, forage grass, switch grass, or a perennial grass system such as a pasture.

Still further provided is a method of making the composition. The method comprises combining urea and a 1,4-NQ, which can inhibit urease, into a composition, i.e., a composition that can be administered to the surface of soil comprising a plant. The 1,4-NQ can be juglone. The method can comprise obtaining granules of urea and coating or impregnating the granules with the 1,4-NQ. The 1,4-NQ can be natural, synthetic, or semi-synthetic. The 1,4-NQ can be purified. The 1,4-NQ can be juglone contained within particulate material obtained from a walnut tree or a pecan tree. The particulate material can be obtained from husks, shells, bark, roots, stems, fruits, and/or leaves of the walnut tree. The particulate material can be obtained from husks, fruits, or both husks and fruits of the walnut tree.

### FIGURES

FIG. 1 shows the structure of the oxidized form of juglone (5-hydroxy-1,4-naphthalenedione).

FIG. 2 is a bar graph bar graph of concentration of juglone vs. % urease activity, showing inhibition of urease with purified juglone.

FIG. 3 is a bar graph of relative amount of walnut husk extract vs. % urease activity, showing inhibition of urease with walnut husk extract.

FIG. 4 is a bar graph of relative levels of free juglone (unconjugated) and total juglone (the sum of its free and conjugated forms) in different, renewable black walnut tree organs.

FIG. 5 is a line graph of turfgrass treatment vs. visual appearance.

### DETAILED DESCRIPTION

Provided is a composition comprising urea and a 1,4-naphthoquinone (1,4-NQ), wherein the 1,4-NQ can inhibit urease. The composition can be used to fertilize a plant. A 1,4-NQ, which can inhibit urease, can have a 5-hydroxy substituent. A 1,4-NQ, which can inhibit urease, can modify a cysteine (such as by binding) at or near the active site of the enzyme, such as in a mobile flap that closes the active site of the enzyme. Additionally, or alternatively, a modification may occur at one or more other amino acid residues of the enzyme. The 1,4-NQ can comprise at least one 1,4-NQ, such as a combination of two or more 1,4-NQs, which inhibit urease. The combination can comprise juglone with one or more other 1,4-NQs, which inhibit urease.

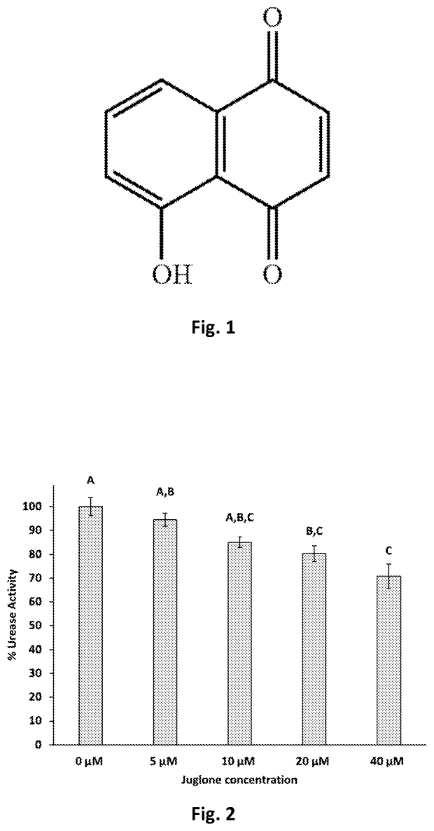

The 1,4-NQ can be juglone (5-hydroxy-1,4-naphthalenedione), which is shown in FIG. 1. It inhibits urease by covalent modification of thiol in the enzyme. Juglone is non-volatile and chemically stable and can be prepared as liquid, semi-solid, and solid formulations (e.g., granules).

The 1,4-NQ, such as juglone, can be sourced from a juglone-producing plant of the family Juglandaceae, such as a member of the genera Carya, Engelhardtia, Juglans, Platycarya and Pterocarya. Examples of species of the genus Juglans include J. nigra, J. cinerea, and J. regia. Juglone can be sourced from walnut trees, such as black walnut trees (J. nigra), white walnut trees (J. cinerea), and English walnut trees (J. regia), and pecan trees (C. illinoensis). Desirably, the juglone is sourced as byproducts of the walnut (or pecan) industry or from renewable parts of the tree, including, for example, the husks, fruits, shells, and/or leaves.

The 1,4-NQ, such as juglone, can be extracted from walnut (or pecan) husks, shells, bark, roots, or leaves, as well as the seed meats, and, if desired, purified. The 1,4-NQ, such as juglone, can be steeped and extracted using an acid or an alcohol. While the plant material can be steeped for less than an hour, longer steeping can result in a more potent extraction. Therefore, the plant material can be steeped for 2, 4, 6, 8, 10, 12, 16, 20 or 24 hours or even longer. The acid can be an organic acid, such as acetic acid, citric acid, or carboxylic acid. The alcohol can be methanol, ethanol, propanol, or a mixture thereof and can further comprise an organic acid or acid anhydride. The alcohol can be ethanol. The alcohol can be present at a concentration of about 10% to about 90%, such as about 20% to about 80%, such as about 30% to about 70%, such as about 40% to about 70%, such as about 50% to about 70%. The extraction may be assisted by heat, ultrasound, sonication, and/or microwaves. A surfactant and/or an emulsifier (e.g., potassium phosphate) can be added to the extract.

Alternatively, a particulate composition, such as a powder, comprising juglone can be made from the walnut (or pecan) husks, shells, bark, roots, stems, fruits, or leaves without extraction and purification of juglone. Samples may be ground and screened, such as through a mesh, e.g., a 45 mesh (0.354). Samples may also be partially extracted and purified. Also, alternatively, juglone can be synthesized with 1,5-dihydroxynaphthalene or the like as a starting material. Thus, the juglone can be natural, synthetic, or semi-synthetic.

Extracts from husks, fruits or both husks and fruits of a walnut tree, in particular a black walnut tree, as well as particulate compositions obtained from husks, fruits or both husks and fruits of a walnut tree, in particular a black walnut tree, may contain other constituents which have a combined or synergistic effect with juglone.

The urea can be particulate, such as granular, and the 1,4-NQ can be coated onto (or impregnated into the surfaces of) the particles, e.g., granules. Alternatively, a mixture of the urea and the 1,4-NQ, such as a homogenous mixture, may be reconstituted into a granule (i.e., granulated). The relative composition of urea to 1,4-NQ resulting from coating, impregnation, or reconstitution into a homogenous granule may result in ratios (expressed as weight/weight or volume/volume) ranging from 1:1,000 to 1,000:1, such as 1:900, 1:800, 1:750, 1:700, 1:600, 1:500, 1:400, 1:300, 1:250, 1:200, 1:100 1:50, 50:1, 100:1, 200:1, 250:1, 300:1, 400:1, 500:1, 600:1, 700:1, 750:1, 800:1, or 900:1. The 1,4-NQ can be natural, synthetic, or semi-synthetic. The 1,4-NQ can be purified. The 1,4-NQ, such as juglone, can be obtained from a plant in the Juglandaceae family, such as a walnut tree or a pecan tree. The 1,4-NQ, such as juglone, can be contained within particulate material obtained from a plant in the Juglandaceae family, such as a walnut tree or a pecan tree. The particulate material can be obtained from husks, shells, bark, roots, stems, fruits, or leaves of the walnut tree. The particulate material can be obtained from husks, fruits, or both husks and fruits of the walnut tree. Juglone also may be obtained from pecan trees and parts thereof.

The 1,4-NQ can be coated onto the urea particles, e.g., granules, or impregnated into the surfaces of the urea particles, e.g., granules, using any suitable method known in the art. The 1,4-NQ can be coated onto the granules using an adsorptive carrier and/or a binder, for example.

Examples of adsorptive carriers include, but are not limited to, inorganic and organic porous materials. Inorganic porous materials include, but are not limited to, clay diatomaceous earth, zeolite, pearlite, zeeklite, sericite, kaolin, pumice, silica, vermiculite, calcium carbonate, and activated clay. Organic porous materials include, but are not limited to, dried plant materials, such as rice hull, sawdust, soybean meal, corn stem, plant fiber, pulp flock, white carbon, and active carbon.

Examples of binders include, but are not limited to, polymeric compounds, such as carboxymethyl cellulose, methyl cellulose, ethyl cellulose, polyvinyl pyrrolidone, polyvinyl alcohol, starch, gum Arabic, hydroxyethyl cellulose, lignin sulfonic acid, gelatin, agar, gum Arabic, xanthan gum, guar gum, locust bean gum, starch, dextrin, tragacanth gum, and polyethylene glycol.

The soil fertilizer composition can comprise other ingredients as known in the art. Examples include adhesives, diluents, excipients (e.g., lactose or cellulose), adjuvants, nutrients, agrochemicals, crop safeners, controlled release systems (e.g., bioplastics or graphene-based nanocarriers) and engineered nanomaterials, and/or other additives (e.g., potassium, phosphorus, calcium, or magnesium) (see, e.g., Lee et al., Front Biomater Sci 1:1011877 (2022)). In various embodiments, the soil fertilizer composition does not comprise a plant systemic inducer, such as salicylic acid, jasmonic acid, isonicotinic acid, dichloroisonicotinic acid, phosphorous acid, cinnamic acid, chitosan, humic acid, and/or a β-1,3-glucan.

Further provided is a method of fertilizing a plant located in soil. The method comprises administering to the surface of the soil the composition. The composition can be administered to the surface of the soil before or after planting seed. If after planting seed, the composition can be administered to the surface of the soil before or after seed germination. If after seed germination, the composition can be administered at any stage of plant maturity—from immature to mature. After plant emergence, the administration may result in contact of the composition with the foliage of the plant. Application of the composition to the surface of the soil reduces hydrolysis of urea at the surface, thereby affording time for the urea to penetrate into the soil with rain, irrigation, and other means. Once the urea reaches a depth of about 5-10 cm, for example, ammonia released from urea can be trapped and mineralized to plant-usable forms.

The plant can be any plant that would benefit from inhibition of urease in the application of a soil fertilizer composition comprising urea. Examples of plants, include, but are not limited to, commercial crops, such as alfalfa, barley, corn, sorghum, cotton, soy bean, beets, sunflower, sugarcane, rape, canola, peanuts, rice, oats, triticale, rye, agave, wheat, potato, tomato, apple, apricot, avocado, banana, blackberry, currant, blueberry, cherry, clementine, coconut, raspberry, cranberry, fig, grapefruit, grape, guava, kiwi, lemon, lime, loganberry, mandarin, mango, melon, nectarine, orange, papaya, peach, pear, pineapple, plum, pomegranate, strawberry, watermelon, almond, beech, butternut, Brazil nut, cashew, chestnut, filbert, hickory, macadamia, pistachio, asparagus, artichoke, bean, pea, cabbage, spinach, pumpkin, squash, eggplant, carrot, broccoli, sweet potato, zucchini, coffee, cocoa, hops, and the like. The plant can be a grass, such as turf grass (e.g., bahia grass, bluegrass, buffalo grass, fescue, bent grass, Bermuda grass, ryegrass, St. Augustine grass, zohsia grass, and the like), forage grass, switch grass, or a perennial grass system such as a pasture.

The composition can be applied to the surface of the soil at any suitable rate as known in the art. Examples include a rate of about 2.5 g nitrogen/m⁻² to 100 g nitogen/m⁻², such as 5 g nitrogen/m⁻² to 95 g nitrogen/m⁻², 10 g nitrogen/m⁻² to 90 g nitrogen/m⁻², 15 g nitrogen/m⁻² to 85 g nitrogen/m⁻², 20 g nitrogen/m⁻² to 80 g nitrogen/m⁻², 25 g nitrogen/m⁻² to 75 g nitrogen/m⁻², 30 g nitrogen/m⁻² to 70 g nitrogen/m⁻², 35 g nitrogen/m⁻² to 65 g nitrogen/m⁻², or 40 g nitrogen/m⁻² to 60 g nitrogen/m⁻². Other examples include a rate of about 0.05 lbs nitrogen/1,000 ft² to 2 lbs nitrogen/1,000 ft², 0.25 lbs nitrogen/1,000 ft² to 1.75 lbs nitrogen/1,000 ft², 0.50 lbs nitrogen/1,000 ft² to 1.50 lbs nitrogen/1,000 ft², or 0.75 lbs nitrogen/1,000 ft² to 1.25 lbs nitrogen/1,000 ft². The composition can be applied in a single application or divided into multiple applications.

Still further provided is a method of making a composition. The method comprises combining urea and a 1,4-NQ, which can inhibit urease, into a composition, i.e., a composition that can be administered to the surface of soil as a fertilizer. The 1,4-NQ can be juglone. The method can comprise obtaining particles, e.g., granules, of urea and coating the granules with the 1,4-NQ. Alternatively, the 1,4-NQ can be impregnated into the surfaces of the particles, e.g., granules. Also, alternatively, a mixture of the urea and the 1,4-NQ, such as a homogenous mixture, may be reconstituted into a granule (i.e., granulated).

The 1,4-NQ can be natural, synthetic, or semi-synthetic. The 1,4-NQ can be purified. The 1,4-NQ can be juglone contained within particulate material obtained from a walnut tree. The particulate material can be obtained from husks, shells, bark, roots, stems, fruits, or leaves of the walnut tree. The particulate material can be obtained from husks, fruits, or both husks and fruits of the walnut tree. The particulate material can be obtained from a pecan tree.

Granulation can be carried out in accordance with conventional granulation techniques known in the art, such as wet extrusion granulation. Granulation can comprise a step of spheronization or a step of drying. In the step of drying, the medium is removed by evaporation. While the configuration and dimensions of the granules are not critical, the overall size of the granules should be sufficiently large to ensure that the granules remain and release juglone at the surface of the soil and allow for the release of urea further down into the soil with rain, irrigation, or other means. The granules may be spherical or cylindrical. The granules may range in size from about 0.5 mm to 5 mm in diameter, such as 0.5 mm to 4.5 mm, 0.5 mm to 4.0 mm, 0.5 mm to 3.5 mm, 0.5 mm to 3.0 mm, 0.5 mm to 2.5 mm, 0.5 mm to 2.0 mm, 0.5 mm to 1.0 mm, 1.0 mm to 5 mm, 1.5 mm to 4.5 mm, 2.0 mm to 4.0 mm, or 2.5 mm to 3.5 mm. Desirably, the granules are of sufficient size to remain at the surface of the soil and release juglone at the surface of the soil and allow for the release of urea further down into the soil.

The urea and 1,4-NQ (e.g., juglone) can be combined (e.g., mixed) by applying a solution of purified, substantially purified, synthesized, or semi-synthesized 1,4-NQ to surfaces of urea particles, e.g., granules, or impregnating a solution of the purified, substantially purified, synthesized, or semi-synthesized 1,4-NQ into the urea particles, e.g., granules. Alternatively, a mixture of the urea and the 1,4-NQ, such as a homogenous mixture, may be reconstituted into a granule (i.e., granulated). Also alternatively, particulate material comprising the 1,4-NQ (e.g., juglone), such as particulate material obtained from a walnut tree can be made into a powder, which can be applied to (or impregnated in) the surfaces of urea particles (e.g., granules), whether alone or in further combination with an adsorptive carrier or binder, for example. Prior to applying the liquid or particulate material to the particles (e.g., granules) of urea, the particles (e.g., granules) can be sprayed with a biodegradable adhesive.

### EXAMPLES

The following examples serve to illustrate the present disclosure. The examples are not intended to limit the scope of the claimed invention in any way.

### Example 1

Inhibition of Urease with Pure Juglone

The results are shown in FIG. 2, which is a bar graph of concentration of juglone vs. % urease activity. Urease 100% activity was measured as 9.6 nmol of ammonia produced per minute. Letters above bars indicate statistical differences using Tukey's multiple comparisons test (α=0.05) and standard error is represented by error bars.

### Example 2

Inhibition of Urease with Walnut Husk Extract

Extracts from green husks (unripe fruits) of black walnut trees were prepared by adding the lyophilized walnut husk powder to reaction buffer, sonicating for 30 minutes, and filtering through a 0.22 μm Millex® membrane.

The 100 μL assays contained 0×, 1× (12.5 μL), 2× (25 μL), or 4× (50 μL) of 20 mg fresh weight mL⁻¹ extract.

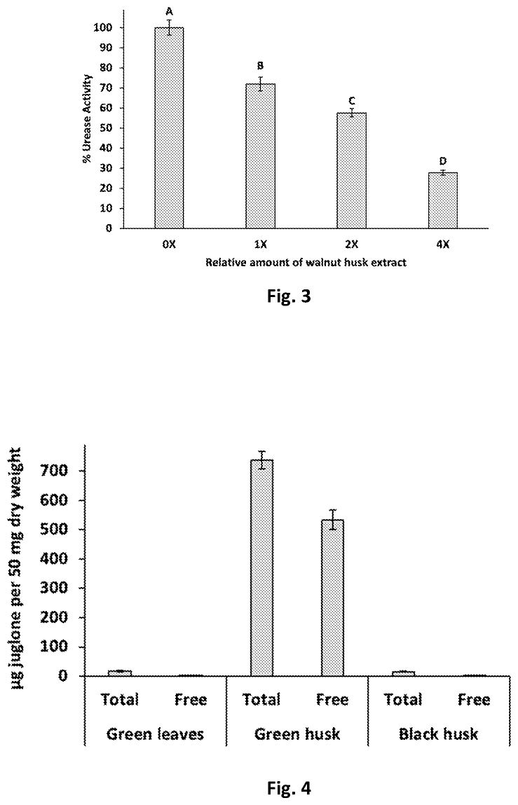

The results are shown in FIG. 3, which is a bar graph of relative amount of walnut husk extract vs. % urease activity, showing inhibition of urease with walnut husk extract.

### Example 3

Quantification of Free (Unconjugated) and Total (Conjugated and Unconjugated) Juglone from Green Leaves, Green Husks (Unripe Fruits), and Black Husks (Ripe Fruits) Collected from Black Walnut Trees

Free and total juglone were quantified (FIG. 4) from 80% methanolic extracts of lyophilized powdered organs using a high-performance liquid chromatography coupled with fluorescence detection (HPLC-FLD) method as described by McCoy et al. (Horticulture Res 5:67 (2018) (doi: 10.1038/s41438-018-0067-5)). To quantify total juglone, samples were acid-hydrolyzed to release free juglone from its conjugated forms. The difference between the measured amount of total juglone and free juglone is equal to the amount of juglone that is present in conjugated forms.

The results are shown in FIG. 4. FIG. 4 is a bar graph depicting relative levels of free juglone (unconjugated) and total juglone (the sum of its free and conjugated forms) in different renewable black walnut tree organs.

### Example 4

Coating Urea Granules with Juglone or Walnut Tree Particulate Material Improves Visual Turf Quality.

A greenhouse study was conducted under standard growth conditions at the Purdue University Plant Growth Facility in West Lafayette, IN, United States. Perennial ryegrass (Lolium perenne L.) was seeded on 4 Aug. 2021 at 294 kg PLS ha⁻¹ in 21.5 cm diameter pots containing a Starks-Fincastle silt loam (fine-silty, mixed, mesic, Aeric Ochraqualf). After establishment, the experimental area received an application of 49 kg N ha⁻¹ on 23 Dec. 2021 using uncoated urea granules or urea granules coated with purified juglone, black walnut tree green husk particulate material, or N-(n-butyl)thiophosphoric triamide (NBPT). A control with no urea was included as a negative control. The soil was kept moist through overhead irrigation occurring 4 d wk⁻¹, totaling approximately 3.8 cm wk⁻¹. Additional fertilizer application using coated urea treatments occurred on 1 Feb. 2022.

The study area was arranged in a randomized block design, and each treatment was replicated four times. Visual turf quality was rated every 8 days using a 0-10 scale, where 0=brown, dead turf: 6=minimally acceptable lawn turf; and 10=optimal uniformity, density, and color as described by Powlen et al. (Crop Science 61:2939-2948 (2021) DOI: 10.1002/csc2.20340).

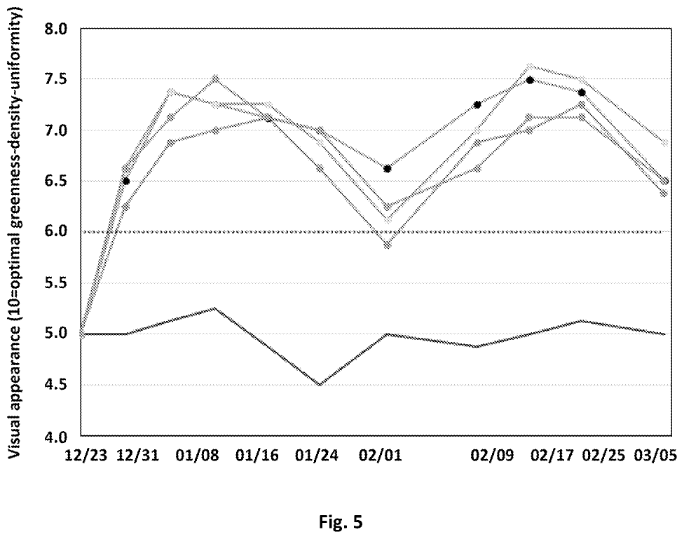

The results are shown in FIG. 5. FIG. 5 is a line graph depicting the visual responses of a cool-season turfgrass to urea-nitrogen fertilization using urea granules with or without coatings of purified juglone, black walnut tree green husk particulate material, or NBPT. The dotted line at 6.0 indicates the minimal acceptable visual performance. The other lines represent, from top to bottom at 02/01, urea-N coated with purified juglone, urea-N coated with NBPT, urea-N coated with walnut tree particulate material, urea-N with no coating, and no urea.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. In the present disclosure the term “about” can allow for a degree of variability in a value or range, for example, within 10%, within 5%, or within 1% of a stated value or of a stated limit of a range. In the present disclosure the term “substantially” can allow for a degree of variability in a value or range, for example, within 90%, within 95%, or within 99% or more of a stated value or of a stated limit of a range.

The terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document: for irreconcilable inconsistencies, the usage in this document controls.

The invention illustratively described herein may be suitably practiced in the absence of any element(s) or limitation(s), which is/are not specifically disclosed herein. Thus, for example, each instance herein of any of the terms “comprising,” “consisting essentially of,” and “consisting of” may be replaced with either of the other two terms.

The terms and expressions, which have been employed, are used as terms of description and not of limitation. Where certain terms are defined and are otherwise described or discussed elsewhere in the “Detailed Description,” all such definitions, descriptions, and discussions are intended to be attributed to such terms. There also is no intention in the use of such terms and expressions of excluding any equivalents of the features shown and described or portions thereof. Furthermore, while subheadings may be used in the “Detailed Description,” such use is solely for ease of reference and is not intended to limit any disclosure made in one section to that section only: rather, any disclosure made under one subheading is intended to constitute a disclosure under each and every other subheading.

All patents, patent application publications, journal articles, textbooks, and other publications mentioned in the specification are indicative of the level of skill of those in the art to which the disclosure pertains. All such publications are incorporated herein by reference to the same extent as if each individual publication were specifically and individually indicated to be incorporated by reference.

It is recognized that various modifications are possible within the scope of the claimed invention. Thus, although the present invention has been specifically disclosed in the context of preferred embodiments and optional features, those skilled in the art may resort to modifications and variations of the concepts disclosed herein. Such modifications and variations are considered within the scope of the invention as claimed herein.

1. A composition comprising urea and a 1,4-naphthoquinone, wherein the 1,4-naphthoquinone (1,4-NQ) can inhibit urease.

2. The composition of claim 1, wherein the 1,4-NQ is juglone.

3. The composition of claim 1, wherein (i) the urea is granular, and the 1,4-NQ is coated onto or impregnated in the granules, or (ii) a homogenous mixture of the urea and the 1,4-NQ is granulated.

4. The composition of claim 1, wherein the 1,4-NQ is natural, synthetic, or semi-synthetic.

5. The composition of claim 1, wherein the 1,4-NQ is purified.

6. The composition of claim 1, wherein the 1,4-NQ is contained within particulate material obtained from a walnut tree or a pecan tree.

7. The composition of claim 6, wherein the particulate material is obtained from husks, shells, bark, roots, stems, fruits, and/or leaves of the walnut tree.

8. The composition of claim 6, wherein the particulate material is obtained from husks, fruits, or both husks and fruits of the walnut tree.

9. A method of fertilizing a plant located in soil, which method comprises administering to the surface of the soil the composition of claim 1, whereupon the plant is fertilized.

10. The method of claim 9, wherein the plant is a grass.

11. A method of fertilizing a plant located in soil, which method comprises administering to the surface of the soil the composition of claim 3, whereupon the plant is fertilized.

12. The method of claim 11, wherein the plant is a grass.

13. A method of fertilizing a plant located in soil, which method comprises administering to the surface of the soil the composition of claim 4, whereupon the plant is fertilized.

14. The method of claim 13, wherein the plant is a grass.

15. A method of fertilizing a plant located in soil, which method comprises administering to the surface of the soil the composition of claim 5, whereupon the plant is fertilized.

16. The method of claim 15, wherein the plant is a grass.

17. A method of fertilizing a plant located in soil, which method comprises administering to the surface of the soil the composition of claim 6, whereupon the plant is fertilized.

18. The method of claim 17, wherein the plant is a grass.

19. The method of claim 17, wherein the particulate material is obtained from husks, shells, bark, roots, stems, fruits, and/or leaves of the walnut tree.

20. The method of claim 19, wherein the plant is a grass.

21. The method of claim 17, wherein the particulate material is obtained from husks, fruits, or both husks and fruits of the walnut tree.

22. The method of claim 21, wherein the plant is a grass.

23. A method of making a composition, which method comprises combining urea and a 1,4-naphthoquinone (1,4-NQ), which can inhibit urease.

24. The method of claim 23, wherein the 1,4-NQ is juglone.

25. The method of claim 23, which method comprises obtaining granules of urea and coating or impregnating the granules with the 1,4-NQ or obtaining granules formed from a homogenous mixture of urea and the 1,4-NQ.

26. The method of claim 23, wherein the 1,4-NQ is natural, synthetic, or semi-synthetic.

27. The method of claim 23, wherein the 1,4-NQ is purified.

28. The method of claim 23, wherein the 1,4-NQ is contained within particulate material obtained from a walnut tree or a pecan tree.

29. The method of claim 28, wherein the particulate material is obtained from husks, shells, bark, roots, stems, fruits, or leaves of the walnut tree.

30. The method of claim 28, wherein the particulate material is obtained from husks, fruits, or both husks and fruits of the walnut tree.
